(19) United States
(12) Patent Application Publication
(10) Pub. No.: US 2026/0297983 A1
(43) Pub. Date: Oct. 1, 2026

(54) INTERLOCKING MECHANISM FOR CABINET WITH MULTIPLE STACKED DRAWERS

(71) Applicant: SJ GLOBAL MARKETING SDN. BHD., Johor (MY)

(72) Inventor: Tan Meng Chong, Johor (MY)

(21) Appl. No.: 19/175,919

(22) Filed: Apr. 10, 2025

(30) Foreign Application Priority Data
Mar. 25, 2025 (MY) PI2025000171

(51) Int. Cl. E05B 65/464; A47B 88/45; A47B 97/00

(52) U.S. Cl. CPC E05B 65/464; A47B 88/45; A47B 97/00; A47B 2097/008

(57) ABSTRACT

An example interlocking mechanism for cabinet with multiple stacked drawers only permits one of the stacked drawers to be drawn opened to access a storage space defined thereto at one time. The interlocking mechanism features a means to switch the interlocking mechanism from an inactivated state to an activated state when the drawers are installed into the cabinet for the first time.

### TECHNICAL FIELD

The present disclosure relates to an interlocking mechanism for cabinet with multiple vertically stacked drawers. More specifically, the disclosed mechanism intrinsically prohibits opening or pulling out of the rest of the drawers when one of the drawers has been pull away from the cabinet.

### BACKGROUND

Cabinets typically have multiple drawers, often filled with various things. When all drawers are closed, the combined weight of the drawers is cantered thus keeping the cabinet stable. Opening a drawer shifts the weight away from the centre and create a force that pulls the cabinet off balance. Cabinets generally retain the stability as long as the remaining closed drawers provide enough weight to keep it upright. However, opening multiple drawers at the same time increases the risk of instability and tipping of the cabinet. Falling of a heavy can cause serious injury to anyone in front of it or damage both the cabinet and its contents. Therefore, different interlocking mechanism have been developed for cabinets to effectuate locking of other drawers passively when one of the drawers has been opened to improve usage safety. For example, U.S. Pat. No. 4,239,309 teaches about equipping a vertical bar with U-shaped hooks to latch onto the drawers thus preventing them from opening when the hooks are shifted vertically. When a drawer is pulled open, a ramp mechanism on its side moves the hook bar upward, locking the remaining drawers and preventing them from being opened simultaneously. Further, U.S. Pat. No. 6,238,024, granted to Sawatzky, details an interlock system that incorporates rigid rods placed vertically between the cabinet drawers. These rods must be sized to match the vertical spacing of the drawers. If the cabinet configuration is altered, new rods corresponding to the updated drawer heights must be installed. Also, U.S. Pat. No. 5,199,774, describes an interlock and lock system that operates using a cable. When a drawer is opened, the cable's slack is reduced. During installation, the cable's slack is precisely adjusted to ensure that only one drawer can be opened at a time. The interlock mechanism of the opened drawer absorbs the available slack, preventing other drawers from being opened simultaneously. Despite the above discussed invention indeed able to deliver the desired outcome, these mechanisms appeared to be complicated to install and prone to malfunction over a period of usage. Hence, a more robust and installation friendly interlocking mechanism would be greatly appreciated.

### SUMMARY

One object of the present disclosure is to provide an interlocking mechanism for cabinet or cabinet system. Specifically, the interlocking mechanism prohibits opening of more than one drawer of the cabinet thus reducing the likelihood of having the cabinet tipping due to imbalance.

Further object of the present disclosure aims to offer an interlocking mechanism equipped with a passive arrangement to switch on or activate the interlocking mechanism upon mounting a predetermined drawer to the cabinet for a first time. The mentioned arrangement frees the user of the disclosed interlocking mechanism from any concern about potential wrongful installation resulting in defective product.

More object of the present disclosure targets to offer an interlocking mechanism incorporated with enhanced features to ensure robustness of the disclosed mechanism to be used over a long period of time without any issues.

At least one of the preceding objects is met, in whole or in part, by the present disclosure, in which one of the embodiments of the present disclosure refers to an interlocking mechanism or system for a cabinet of a plurality of vertically stacked drawers, each slidably mounting onto internal sidewalls of the cabinet through a pair of guide rails and being pullable away from a back of the cabinet through a front of the cabinet to open the drawer. Preferably, the disclosed mechanism comprises a track having a top end and a bottom end, the track running along a height of one of the internal sidewalls defining a lengthwise canal; a top stoppage piece and a bottom stoppage piece being secured within the canal around the top end and the bottom end of the track with a dowel projecting perpendicularly away from the top stoppage piece out of the track; a plurality of triggers each mounted to an external sidewall of a corresponding drawer; a plurality of locking assembly slidably fitted into the canal in a sequential manner and downstream of the top stoppage piece, each locking assembly comprising a pivot base, a locking cam rotatably fixed to the pivot base moveable in between an open position and a close position in connection to the opening and closing of a corresponding drawer respectively upon engaging the locking cam to the corresponding drawer through the trigger, a spacer slidably displaceable away or towards the pivot base respectively corresponding to the open position and the close position of the locking cam, and at least one connector; at least one connection rod joining a preceding locking assembly to an immediate succeeding locking assembly using the connector of each locking assembly; a coil spring sandwiched between the top stoppage piece and a topmost locking assembly being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa; a latch having a front end and a back end respectively facing the front and the back of the cabinet being slidably mounted onto the internal sidewall of the cabinet, the latch carrying a thorough groove to accommodate the dowel therein, the groove extending from the back end towards the front end, the groove comprising an upper section inclining towards a lower section through an inclined section with the upper section being positioned relatively higher than lower section on a planar surface of the latch; and an actuator attached to an external sidewall of a topmost drawer to engage with the latch upon insertion of the topmost drawer into the cabinet for a first time. More preferably, the interlocking mechanism is at an inactivated state which insertion of the drawers other than the topmost drawer aligns the trigger of each inserted drawers with the corresponding locking cam free from any physical engagement with a void presented downstream of the track. More preferably, the interlocking mechanism is activated by way of inserting the topmost drawer into the cabinet for the first time, after insertion of the rest of the drawers, pushing the latch towards the back of the cabinet using the actuator leading to moving of the dowel from the upper section to the lower section displacing the track and the downstream locking assembly within the canal downwardly to fill the void while physically engaging the locking cams to the trigger.

For some embodiments, the canal is out of moveable space when the coil spring is at the second compressed level with one of the locking assembly being switched to the open position thus prohibiting other locking assembly in the close position to adapt the open position.

For some embodiments, the spacer comprises a wedge shaped on the planar surface to contact with a surface profile (144) carved around at least a portion of a circumference of the locking cam that sliding the wedge against the surface profile (144) yanks the spacer progressively away from the pivot base upon turning the locking cam to the open position from the close position.

For some embodiments, the locking cam further comprises a first bump raised from the circumference of the locking cam adjacent to the surface profile to abut onto the wedge and stop the wedge from moving beyond upon resuming the close position by the locking cam.

For some embodiments, the first bump of a topmost locking assembly of the plurality of the locking assembly protruding further upward forming an arm to engage with the latch such that the topmost locking cam in the close position is turned to the open position upon insertion of the topmost drawer for the first time.

In more embodiments, the surface profile (144) comprises a convex ramp portion followed by a beveled seat with a converging point formed in between the ramp and the seat at which the wedge resting on the locking cam upon the locking cam adapts the open position.

In more embodiments, the locking cam further comprising a second bump raised from the circumference of the locking cam adjacent to the seat to abut onto the wedge and stop the wedge from moving beyond upon adapting the close position by the locking cam.

In more embodiments, the locking cam located downstream of the topmost locking cam has the converging point smoothened or flattened in relation to the topmost locking cam to dampen sound produced when the locking cam switches between the close position and the open position.

In more embodiments, the latch is fabricated with a cutoff area around the back end to accommodate part of the arm therein prior to engaging the latch with the actuator.

In more embodiments, the trigger is free from being integrated into one of the paired guide rails compared to some other conventional mechanism.

### BRIEF DESCRIPTION OF THE DRAWINGS

FIG. 1 shows perspective explosive view of one embodiment of the interlocking mechanism without the trigger;

FIG. 2 shows position of the trigger, compatible with the embodiment shown in FIG. 1, in relation to the guide rails;

FIG. 3 shows the embodiment of FIGS. 1 and 2 being assembled;

FIGS. 4A-4F respectively show one embodiment of the latch, the trigger, the track, the coil spring, the connection rod, and the strap of the interlocking mechanism of FIG. 1;

FIGS. 5A-5B respectively show one embodiment of the spacer used in the topmost locking assembly and the rest of the locking assembly;

FIGS. 6A-6B respectively show one embodiment of the locking cam used in the topmost locking assembly and the rest of the locking assembly;

FIG. 7 shows one embodiment of the pivot base carrying a connector;

FIGS. 8A-8B respectively show one embodiment of the top stoppage piece and the bottom stoppage piece; and

FIGS. 9A-9B respectively show one embodiment of the actuator being mounted on one of the side of the drawer and engagement of the actuator with the latch upon insertion of the topmost drawer.

### DETAILED DESCRIPTION

The present disclosure may be embodied in other specific forms without departing from its structures, methods, or other essential characteristics as broadly described herein and claimed hereinafter. The described embodiments are to be considered in all respects only as illustrative, and not restrictive. The scope of the disclosure is, therefore, indicated by the appended claims, rather than by the foregoing description. All changes that come within the meaning and range of equivalency of the claims are to be embraced within their scope.

As used herein, the terms “approximately” or “about”, in the context of concentrations of components, conditions, other measurement values, etc., means +/−5% of the stated value, or +/−4% of the stated value, or +/−3% of the stated value, or +/−2% of the stated value, or +/−1% of the stated value, or +/−0.5% of the stated value, or +/−0% of the stated value.

The directional term such as “top”, “bottom”, “parallel”, “side”, “perpendicular”, “external”, “internal”, “vertical” and “horizontal” used throughout herein the specification generally refers to the relative direction of the various components of the disclosed mechanism or system with regard to the position of the cabinet installed with the disclosed mechanism.

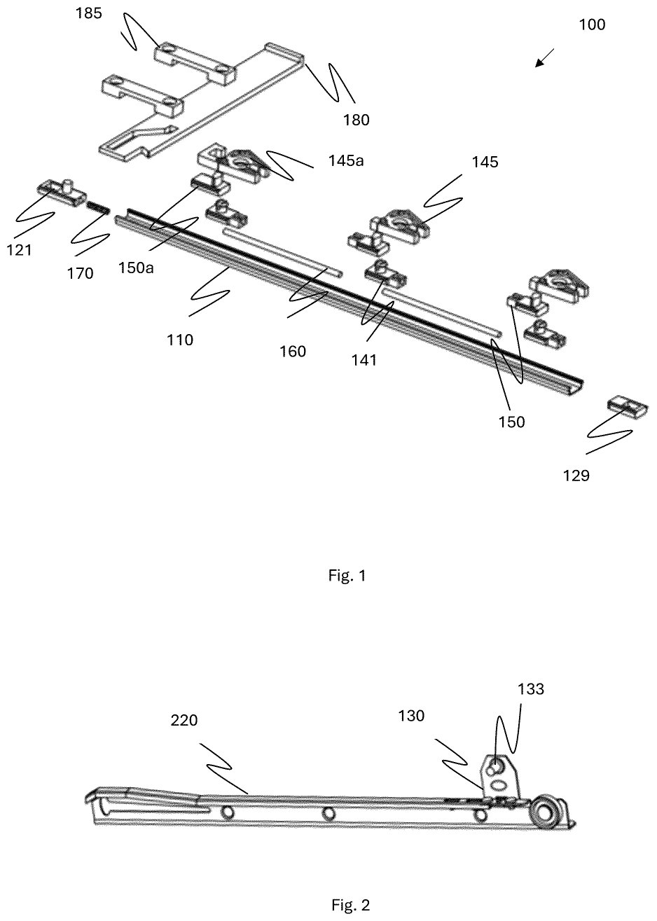

Referring to FIGS. 1-3, one embodiment of the disclosed interlocking mechanism (100) is illustrated. Particularly, the disclosed interlocking mechanism (100) is to be installed for a cabinet (200) of a plurality of vertically stacked drawers (210), each slidably mounting onto internal sidewalls of the cabinet (200) through a pair of guide rails (220) and being pullable away from a back of the cabinet (200) through a front of the cabinet (200) to open the drawer (210). Essentially, the interlocking mechanism (100) comprises a track (110) having a top end and a bottom end, the track (110) running along a height of one of the internal sidewalls defining a lengthwise canal (111); a top stoppage piece (121) and a bottom stoppage piece (129) being secured within the canal (111) around the top end and the bottom end of the track (110) with a dowel (123) projecting perpendicularly away from the top stoppage piece (121) out of the track (110); a plurality of triggers (130) each mounted to an external sidewall of a corresponding drawer (210); a plurality of locking assembly (140) slidably fitted into the canal (111) in a sequential manner and downstream of the top stoppage piece (121), each locking assembly (140) comprising a pivot base (141), a locking cam (145) rotatably fixed to the pivot base (141) moveable in between an open position and a close position in connection to the opening and closing of a corresponding drawer (210) respectively upon engaging the locking cam (145) to the corresponding drawer (210) through the trigger (130), a spacer (150) slidably displaceable away or towards the pivot base (141) respectively corresponding to the open position and the close position of the locking cam (145), and at least one connector (168); at least one connection rod (160) joining a preceding locking assembly (140) to an immediate succeeding locking assembly (140) using the connector (168) of each locking assembly (140); a coil spring (170) sandwiched between the top stoppage piece (121) and a topmost locking assembly (140a) being switchable between a first compressed level and an optimal second compressed level to constantly apply a tension force towards the plurality of locking assembly (140) positioned downstream, the coil spring (170) of the first compressed level being compressible further to the second compressed level providing a moveable space or room within the canal (111) for one of the spacers (150) to displace away from the pivot base (141) upon the open position adapted by the corresponding locking assembly (140) and vice versa; a latch (180) having a front end and a back end respectively facing the front and the back of the cabinet (200) being slidably mounted onto the internal sidewall of the cabinet (200), the latch (180) carrying a thorough groove (181) to accommodate the dowel (123) therein, the groove (181) extending from the back end towards the front end, the groove (181) comprising an upper section (182) inclining towards a lower section (184) through an inclined section (183) with the upper section (182) being positioned relatively higher than lower section (184) on a planar surface of the latch (180); and an actuator (190) attached to an external sidewall of a topmost drawer (210a) to engage with the latch (180) upon insertion of the topmost drawer (210a) into the cabinet (200) for a first time. Preferably, the interlocking mechanism (100) is at an inactivated state insertion of the drawers (210) other than the topmost drawer (210a) aligns the trigger (130) of each inserted drawers (210) with the corresponding locking cam (145) free from any physical engagement with a void presented downstream of the track (110). Also, the interlocking mechanism (100) is activated by way of inserting the topmost drawer (210a) into the cabinet (200) for the first time, after insertion of the rest of the drawers (210), pushing the latch (180) towards the back of the cabinet (200) using the actuator (190) leading to moving of the dowel (123) from the upper section (182) to the lower section (184) displacing the track (110) and the downstream locking assembly (140) within the canal (111) downwardly to fill the void while physically engaging the locking cam (145) to the trigger (130).

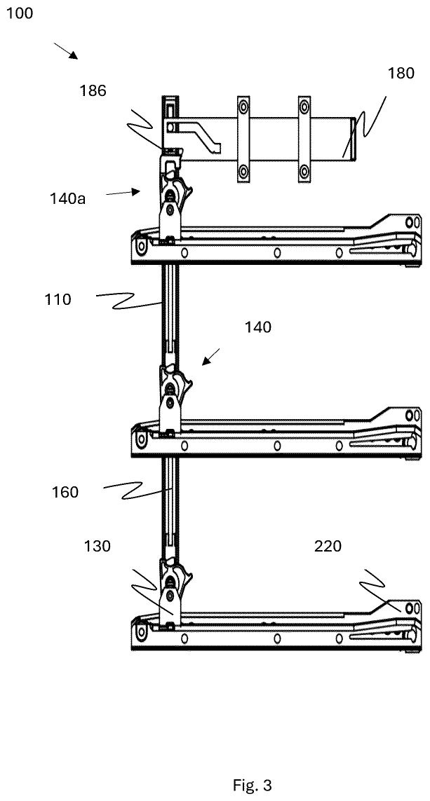

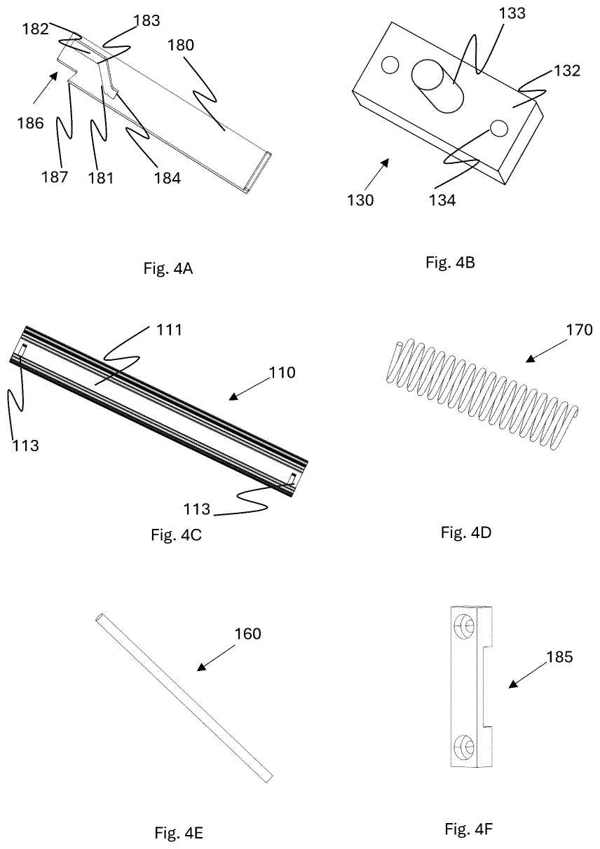

From FIG. 3, one embodiment of the assembled interlocking mechanism (100) can be seen. The assembled interlocking mechanism (100) or system houses the dowel (123) of the top stoppage piece (121) around the back end within the upper section (182) of the groove (181) while the latch (180) poises to slidably intersecting the vertically standing track (110). A pair of straps (185) with the aid of screws are used to mount the latch (180) onto the internal sidewall of the cabinet (200) yet permitting limited gliding movement of the latch (180) in relation to the straps (185). FIG. 4A further reveals the detailed view of the latch (180) which the cutoff (186) has a slanted side edge to give rise of a pointy corner (187) to contact an arm (146) of the topmost locking cam (145a) and push the arm (146) backward to rotate the topmost locking cam (145a) into the open position. Preferably, the latch (180) is fabricated with a cutoff (186) around the back end to accommodate part of the arm (146) therein prior to engaging the latch (180) with the actuator (190). More specifically, one can envision from FIG. 3 that sliding of the latch (180), from the push of the actuator (190) in connection to the insertion of the topmost drawer (210a) for the first time, towards the track (110) inevitably shifts the dowel (123) into the lower section (184) of the groove (181) passing through the inclined section (183). The upper section (182) is at a higher level than the lower section (184) around the vertical plane. By shifting the dowel (123) to a lower level at the lower section (184), the latch (180) coerces the top stoppage piece (121) to displace downwardly along with the track (110), which the top stoppage piece (121) tied to, pushing at least part of the bottom stoppage piece (129) into the void. Other components located downstream of the top stoppage piece (121) within the canal (111) shall be displaced along to finally resulting in activation of the disclosed mechanism (100).

It is important to note that the topmost locking cam (145a) takes the open position to receive the trigger (130) of the inserting topmost drawer (210a) then being rotationally shoved backward or turn clockwise in connection to the movement of the inserting topmost drawer (210a). Once the topmost drawer (210a) has been fully retracted into the cabinet (200), the topmost locking cam (145a) resumes a close position while the disclosed mechanism (100) becomes activated with part of the track (110) filled into the void. For a number of the disclosed embodiments, the trigger (130), as present in FIG. 4B, comprises a base (132) and a pole (133) projecting away from the planar surface of the base (132). The base (132) may bear one or more screw holes (134) for fixing the base (132) onto the external surface of the sidewall of the drawer (210). Thus, the trigger (130), in these embodiments, is free from being integrated into one of the paired guide rails (220). Such design of the trigger (130) facilitates application of the disclosed mechanism (100) to any other existing cabinet or cabinet system to obtain the interlocking outcome without much hassle, as long as the trigger (130) is fixed to the external surface of the sidewall of the drawer (210) corresponding to the position of the locking assembly (140) which the trigger (130) to be engaged with.

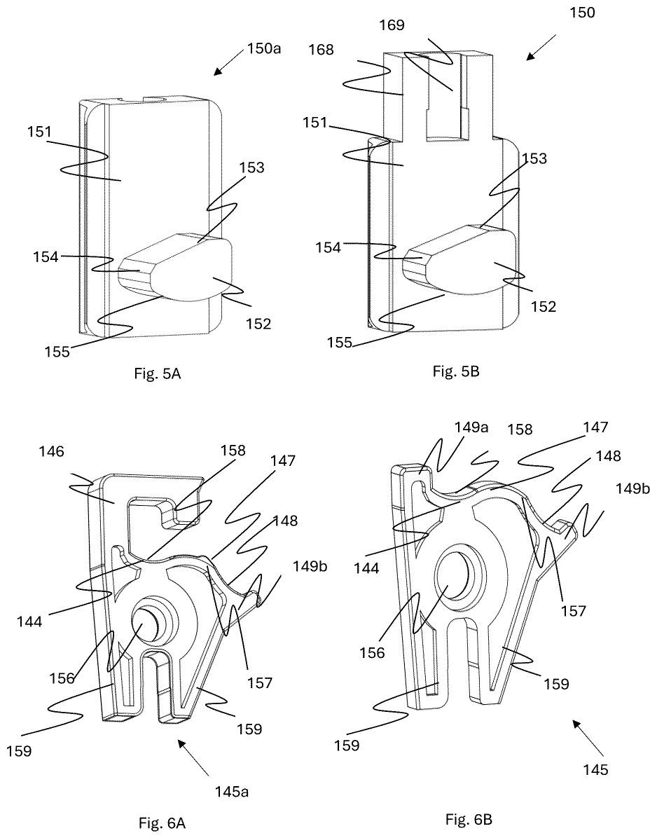

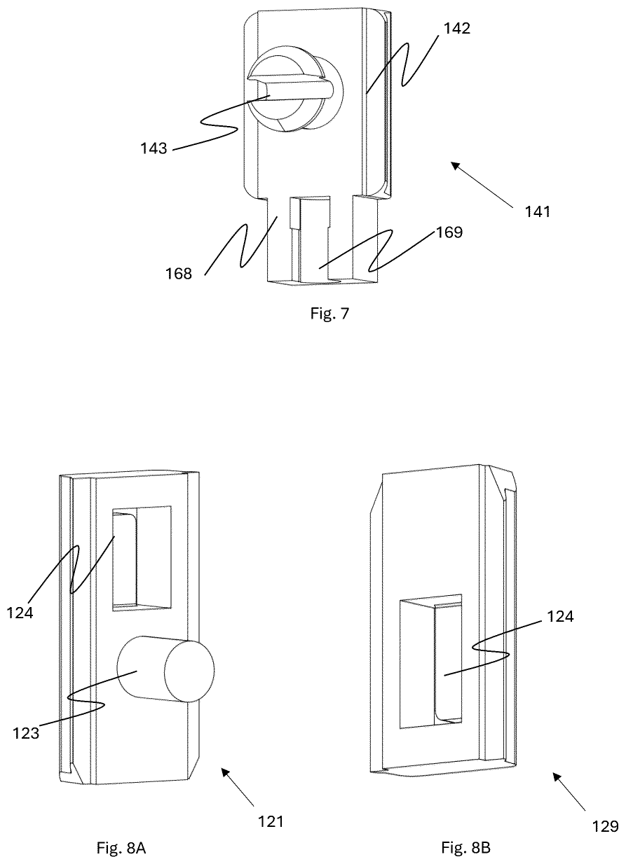

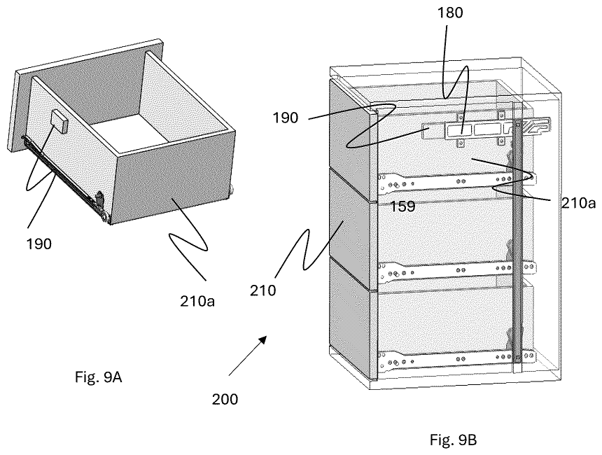

As mentioned in the foregoing description, the locking assembly (140) comprises at least three different parts comprises the spacer (150) as illustrated in FIGS. 5A-5B, the locking cam (145) shown in FIGS. 6A-6B, and the pivot base (141) present in FIG. 7. Preferably, all these parts are shaped and sized to have identical or almost identical width and thickness such that these parts can be naturally fitted into the canal (111) and capable of sliding within the canal (111) in connection to the switching of the open and close position of the locking cam (145) of one of the locking assembly (140). FIG. 5A and FIG. 5B respectively show one embodiment of the topmost spacer (150a) used for the topmost locking assembly (140a) and the spacer (150) constructing the locking assembly (140) other than the topmost variant. In general, the spacer (150) is an elongate block (151) carrying a wedge (152) on its planar surface facing the external surface of the sidewall of the drawer (210). The bottom circumference of the wedge (152) is designated to contact with a surface profile (144) carved around at least a portion of a circumference of the corresponding locking cam (145) that sliding the wedge (152) against the surface profile (144) yanks the spacer (150) progressively away from the pivot base (141) upon turning the locking cam (145) to the open position from the close position. Owing to the convex or raising ramp (147) on the surface profile (144) of the locking cam (145), rotational movement of the locking cam (145) is translated into a linear motion of the corresponding spacer (150) upward further compressing the coil spring (170) towards the second compressed level. At the second compressed level, the coil spring (170) is fully or almost fully compressed that further compression is likely to cause irreversible damage to the coil spring (170). The maximum distance of the spacer (150) being displaceable away from the pivot base (141) in connection to the switching of the close position to the open position by the locking assembly (140) shall equal or correspond to the linear compression or linear changes in length of the coil spring (170) adapting the second compressed level from the first compressed level. The top circumference of the wedge (152) may be shaped to have a top bevel (153) with a land (154) forming one of the side circumferences then progressively curves into the bottom convex or arc circumference (155). Another side circumference of the wedge (152) is flattened as shown in FIGS. 6A-6B. The arc bottom circumference (155) facilitates sliding of the wedge (152) about the surface profile (144) of the locking cam (145) free from any significant friction that may cause wearing of the surface profile (144) after long period of use of the cabinet (200). For the variant in FIG. 5B, a connector (168) or an upward connector becomes an upward extension from the elongate block (151) defining a channel (169) for snug fitting or reception of the connection rod (160) thereto. Since the topmost variant of the spacer (150) has no need to fasten onto the connection rod (160), the topmost variant of the spacer (150) is free from having the connector (168) as illustrated in FIG. 5a. Nonetheless, the back (not shown) of the topmost spacer (150a) may carry a cannel (not shown) for fitting in of the part of the coil spring (170) to restrict any undesired movement of the coil spring (170) within the canal (111) other than required compression and decompression.

Correspondingly, FIG. 6A and FIG. 6B respectively illustrate one embodiment of the topmost lock cam (145a) and the lock cam (145) other than the topmost variant of the locking assembly (140). The locking cam (145) appears as a planar piece with a through aperture (156) fabricated around the centre for coupling with the pivot base (141) to realize the rotational movement for switching between the open position and the close position. Preferably, the locking cam (145) retains a predetermined thickness to have sufficient surface area directed to physical engagement with the wedge (152) of the spacer (150) and the pole (133) of the trigger (130). The disclosed mechanism (100) preferably disposes the surface profile (144) around the top circumference of the locking cam (145). The surface profile (144) comprises a convex ramp (147) portion followed by a beveled seat (148) extending sideway with a converging point (157) formed in between the ramp (147) and the seat (148) at which the wedge (152) resting on the locking cam (145) upon the locking cam (145) adapts the open position. Particularly, the wedge (152) rests on the trough (158) of the ramp (147) when the given locking assembly (140) is in the close position. The wedge (152) advances across the ramp (147) to reach the seat (148) to adapt the open position from the trough (158). The wedge (152) engages onto the seat (148) when the given locking assembly (140) is in the open position. More preferably, the locking cam (145) further comprises a first bump (149a) raised from the circumference of the locking cam (145) adjacent to the surface profile (144) to abut onto the wedge (152) and stop the wedge (152) from moving beyond upon resuming the close position by the locking cam (145).

Similarly, the locking cam (145) further comprises a second bump (149b) raised from the circumference of the locking cam (145) adjacent to the seat (148) to abut onto the wedge (152) and stop the wedge (152) from moving beyond upon adapting the open position by the locking cam (145). Also, the first bump (149a) of the topmost locking assembly (140a) of the plurality of the locking assembly (140) protruding further upward forming an arm (146) to engage with the latch (180) such that the topmost locking cam (145a) in the close position is turned to the open position upon insertion of the topmost drawer for the first time. Furthermore, the locking cam (145) further comprises a pair of bifurcated prongs (159) projecting downward and away around the bottom circumference with a slot defined in between the prongs (159). The paired prongs (159) are designated to physically engage with the trigger (130) when the disclosed mechanism (100) is activated, and the given locking cam (145) is in the close position. Particularly, the pole (133) of the trigger (130) shall glide into the slot of the corresponding locking cam (145) upon insertion of the corresponding drawer (210). Still, in more embodiments, the locking cam (145) located downstream of the topmost locking cam (145a) has the converging point (157) smoothened or flattened in relation to the topmost locking cam (145a) to dampen sound produced when the locking cam (145) switches between the close position and the open position.

To realize rotational movement of the locking cam (145), one embodiment of the pivot base (141) is illustrated in FIG. 7. The pivot base (141) preferably comprises an elongate body (142) on which a pivot hinge (143) is fabricated to be inserted and coupled to the through aperture (156) of the locking cam (145) for enabling the rotational movement thereby. Similarly, the body (142) of the pivot base (141) further comprises a connector (168) or a downward connector, which is a downward extension from the elongate body defining a channel (169) for snug fitting or reception of the connection rod (160). Two successive locking assemblies of the disclosed mechanism (100) can be connected by having the downward connector from the pivot base (141) of a preceding locking assembly (140) and the upward connector from the spacer (150) of a succeeding locking assembly (140) fastening onto a top tip and bottom tip of a connection rod (160) respectively.

Attention shall now be given to FIGS. 8A-8B showing one embodiment of the top and bottom stoppage piece (129) respectively. The top stoppage piece (121) comprises a planar block to reside within the canal (111) and the dowel (123) perpendicularly protruding away from the block outreaching the depth of the canal (111) to be held at the through groove (181) of the latch (180). The back of the block preferably incorporated with a fitting to tie the top stoppage piece (121) to a corresponding bore (113) around the top end of the track (110). Similarly, the bottom stoppage piece (129) comprises the planar block without the dowel (123) but carrying the like fitting to mount on the corresponding bore (113) at the bottom end of the track (110). A depression (124) can be seen on the front of the block to denote the location of the fitting at the back.

Pursuant to the preferred embodiments, most of the components except the trigger (130), actuator (190), etc. are mounted or resided in the track (110) directly or indirectly. The track (110) is preferably snugly resided in a longitudinal recess (not shown) fabricated on the internal sidewalls of the cabinet (200). The recess may have a length greater than the length of the track (110) in some of the embodiments such that the void is located downstream of the of track (110) within the recess. The track (110) is suspended on top of the void before activation of the disclosed mechanism (100) or system by inserting the topmost drawer (210a). To secure the suspension of the track (110), a sleeve, like the straps (185), maybe used to wrap around the top end of the track (110). The track (110), as shown in 4c, may possess a pair of bores (113) each respectively positioned around the top and bottom end for respective securement of the top (121) and bottom stoppage piece (129). Under the compelling force of the dowel (123), the track (110) along with other mounting components such as the locking assemblies, top (121) and bottom stoppage pieces (129), the connection rods (160), etc. move downward having the bottom stoppage piece (129) abutted onto the end of the recess.

It is crucial to note that the various components of the disclosed interlocking mechanism (100) are preferably installed to the drawers (210) and the cabinet (200) according to the predetermined manner to yield the desired outcome. After the installation of the components, the disclosed interlocking mechanism (100) has to be activated through insertion of the drawers (210) following a preferred sequence. More specifically, the track (110) hoovers on top of the void and all the locking assemblies are placed in the close position with the slot of each locking cam (145) facing downward before the activation of the disclosed mechanism (100). To activate the disclosed interlocking mechanism (100) or system, one shall insert drawers (210) other than the topmost drawer (210a) into the cabinet (200) aligning the pole (133) of the trigger (130) to the corresponding locking assembly (140) with the slot of the locking cam (145) of the corresponding locking assembly (140) suspended above the pole (133) free from any physical engagement. The topmost drawer (210a) being inserted the last for the first time inevitably pushes the latch (180) backward forcing the dowel (123) to traverse from the upper section (182) to the lower section (184) of the through groove (181) that driving the entire track (110) and the components mounting thereto to move downward filling the void by the bottom stoppage piece (129). In the meantime, the slot of locking cam (145) moves downward too for physically engaging with the pole (133) of the trigger (130). The topmost locking cam (145a) is instead pushed to adapt the open position at first exposing the slot for the pole (133) of the trigger (130) of the topmost drawer (210a) to engage then being turned back to the close position by the trigger (130) upon full insertion of the topmost drawer (210a). Once the disclosed interlocking mechanism (100) becomes activated and all the interlocking assemblies are at the close position, all the components resided in the canal (111) are subjected to the tension force applied downward from the coil spring (170) of the first compressed level holding the components in place. Yet the moveable or displaceable space exits under the condition where the coil spring (170) is depressed further to reach the second compressed level. The displaceable or moveable space corresponds to the linear changes of the length of the coil spring (170) upon further compression. The optimal moveable or displaceable space shall be in line with optimal linear changes of the length of the coil spring (170) until it reaches the second compressed level and the distance the spacer (150) being displaced away from the pivot base (141) when the given locking assembly (140) takes the open position. When one of the locking assemblies takes the open position, the locking cam (145) of the given locking assembly (140) yanks the spacer (150) away pressing the coil spring (170) to adapt the second compressed level while the wedge (152) traverse across the surface profile (144) to arrive at and rest on the seat (148) of the surface profile (144). At the same time, the slot of the locking cam (145) of the given assembly (140) is turned forward for the trigger (130) to slidable disengages from the given locking assembly (140) to realize opening of the drawer (210). The distance separating the spacer (150) and the pivot base (141) occupies or uses up the moveable space rendering insufficient space within the canal (111) for the rest of the locking assemblies to rotate and release the disengage the trigger (130). In more specific, the canal (111) is out of moveable space when the coil spring (170) is at the second compressed level with one of the locking assembly (140) being switched to the open position thus prohibiting other locking assembly (140) in the close position to adapt the open position.

It is to be understood that the present disclosure may be embodied in other specific forms and is not limited to the sole embodiment described above. However, modification and equivalents of the disclosed concepts such as those which readily occur to one skilled in the art are intended to be included within the scope of the claims which are appended thereto.

1. An interlocking mechanism for a cabinet of a plurality of vertically stacked drawers, each slidably mounting onto internal sidewalls of the cabinet through a pair of guide rails and being pullable away from a back of the cabinet through a front of the cabinet to open the drawer, comprising:
a track having a top end and a bottom end, the track) running along a height of one of the internal sidewalls defining a lengthwise canal;
a top stoppage piece and a bottom stoppage piece being secured within the canal around the top end and the bottom end of the track with a dowel projecting perpendicularly away from the top stoppage piece out of the track;
a plurality of triggers each mounted to an external sidewall of a corresponding drawer;
a plurality of locking assembly slidably fitted into the canal in a sequential manner and downstream of the top stoppage piece, each locking assembly comprising a pivot base, a locking cam rotatably fixed to the pivot base moveable in between an open position and a close position in connection to the opening and closing of a corresponding drawer respectively upon engaging the locking cam to the corresponding drawer through the trigger, a spacer slidably displaceable away or towards the pivot base respectively corresponding to the open position and the close position of the locking cam, and at least one connector;
at least one connection rod joining a preceding locking assembly to an immediate succeeding locking assembly using the connector of each locking assembly;
a coil spring sandwiched between the top stoppage piece and a topmost locking assembly being switchable between a first compressed level and an optimal second compressed level to constantly apply a tension force towards the plurality of locking assembly positioned downstream, the coil spring of the first compressed level being compressible further to the second compressed level providing a moveable space within the canal for one of the spacers to displace away from the pivot base upon the open position adapted by the corresponding locking assembly and vice versa, the second;
a latch having a front end and a back end respectively facing the front and the back of the cabinet being slidably mounted onto the internal sidewall of the cabinet, the latch carrying a thorough groove to accommodate the dowel therein, the groove extending from the back end towards the front end, the groove comprising an upper section inclining towards a lower section through an inclined section with the upper section being positioned relatively higher than lower section on a planar surface of the latch; and
an actuator attached to an external sidewall of a topmost drawer to engage with the latch upon insertion of the topmost drawer into the cabinet for a first time;
wherein the interlocking mechanism is at an inactivated state which insertion of the drawers other than the topmost drawer aligns the trigger of each inserted drawers with the corresponding locking cam free from any physical engagement with a void presented downstream of the track,
wherein the interlocking mechanism is activated by way of inserting the topmost drawer into the cabinet for the first time, after insertion of the rest of the drawers, pushing the latch towards the back of the cabinet using the actuator leading to moving of the dowel from the upper section to the lower section displacing the track and the downstream locking assembly within the canal downwardly to fill the void while physically engaging the locking cams to the trigger.

2. The interlocking mechanism of claim 1, wherein the spacer comprises a wedge shaped on the planar surface to contact with a surface profile carved around at least a portion of a circumference of the locking cam that sliding the wedge against the surface profile yanks the spacer progressively away from the pivot base upon turning the locking cam to the open position from the close position.

3. The interlocking mechanism of claim 2, wherein the locking cam further comprises a first bump raised from the circumference of the locking cam adjacent to the surface profile to abut onto the wedge and stop the wedge from moving beyond upon resuming the close position by the locking cam.

4. The interlocking mechanism of claim 3, wherein the first bump of a topmost locking assembly of the plurality of the locking assembly protruding further upward forming an arm to engage with the latch such that the topmost locking cam in the close position is turned to the open position upon insertion of the topmost drawer for the first time.

5. The interlocking mechanism of claim 2, wherein the surface profile comprises a convex ramp portion followed by a beveled seat with a converging point formed in between the ramp and the seat at which the wedge resting on the locking cam upon the locking cam adapts the open position.

6. The interlocking mechanism of claim 5 further comprising a second bump raised from the circumference of the locking cam adjacent to the seat to abut onto the wedge and stop the wedge from moving beyond upon adapting the open position by the locking cam.

7. The interlocking mechanism of claim 5, wherein the locking cam located downstream of the topmost locking cam has the converging point smoothened or flattened in relation to the topmost locking cam to dampen sound produced when the locking cam switches between the close position and the open position.

8. The interlocking mechanism of claim 2, wherein the latch is fabricated with a cutoff around the back end to accommodate part of the arm therein prior to engaging the latch with the actuator.

9. The interlocking mechanism of claim 2, wherein the trigger is free from being integrated into one of the paired guide rails.

10. The interlocking mechanism of claim 1, wherein the canal is out of moveable space when the coil spring is at the second compressed level with one of the locking assembly) being switched to the open position thus prohibiting other locking assembly in the close position to adapt the open position.
